(19) United States
(12) Patent Application Publication
(10) Pub. No.: US 2007/0073966 A1
(43) Pub. Date: Mar. 29, 2007

(54) Network processor-based storage controller, compute element and method of using same

(76) Inventor: John R. Corbin, El Paso, TX (US)

Correspondence Address: PEACOCK MYERS, P.C., 201 THIRD STREET, N.W., SUITE 1340, ALBUQUERQUE, NM, 87102, US

(21) Appl. No.: 11/235,447

(22) Filed: Sep. 23, 2005

(51) Int. Cl. G06F 12/16

(52) U.S. Cl. 711/114

(57) ABSTRACT

A data storage controller providing network attached storage and storage area network functionality comprising a network processor (37) and providing for volume management (preferably one or more of mirroring, RAID5, and copy on write backup), caching of data stored, protocol acceleration of low level protocols (preferably one or more of ATM, Ethernet, Fibre Channel, Infiniband, Serial SCSI, Serial ATA, and any other serializable protocol), and protocol acceleration of higher level protocols (preferably one or more of IP, ICMP, TCP, UDP, RDMA, RPC, security protocols, preferably one or both of IPSEC and SSL, SCSI, and file system services, preferably one or both of NFS and CIFS).

### RELATED APPLICATIONS

The present application is related to U.S. Provisional Patent Application Ser. No. 60/319,999, entitled “APPARATUS AND METHOD FOR A NETWORK PROCESSOR-BASED STORAGE CONTROLLER”, of John Corbin, which application was filed on Mar. 11, 2003; and U.S. Provisional Patent Application Ser. No. 60/320,029, entitled “APPARATUS AND METHOD FOR A NETWORK PROCESSOR-BASED COMPUTE ELEMENT”, of John Corbin, which application was filed on Mar. 20, 2003. This application is also related to Patent Cooperation Treaty Application No. US04/06311, entitled “NETWORK PROCESSOR-BASED STORAGE CONTROLLER, COMPUTE ELEMENT AND METHOD OF USING SAME”, which international application was filed on Mar. 2, 2004.

### BACKGROUND OF THE INVENTION

1. Field of the Invention

The present invention relates to compute servers and also computational clusters, computational farms, and computational grids. More particularly, the present invention relates to an apparatus and method for a network processor-based storage controller that allows the storage and retrieval of information by data processing devices. The storage controller is located between the data processing device and the persistent computer data storage. The data may be stored on any type of persistent storage such as magnetic disc drive, magnetic tape, optical disc, non-volatile random access memory, or other devices currently in use for providing persistent storage to data processing devices. More particularly, the present invention relates to an apparatus and method for a Network Processor-based Compute Element that provides computational capabilities to a computational grid, or it can provide computing power for a computer server. The computational grid or computer server can be made up of one or more Network Processor-based Grid Compute Elements. The number of compute elements used depends on how much computing power is desired.

2. Description of the Related Art

Data processing devices typically require a persistent place to store data. Initially persistent storage devices like magnetic disc drives were used and directly connected to the data processing device. This approach is still used on many personal computers today. As the data storage requirements of data processing devices increased, the number of disc drives used increased, and some of the data processing device's processing cycles were used to manage the disk drives. In addition, the maximum performance of this type of solution when accessing a single data set was limited to the performance of a single disk drive since a single data set could not span more than one drive. Limiting a single data set to one drive also meant that if that drive failed then the data set was no longer available until it could be loaded from a backup media. Finally, the effort required to manage the disk drives scaled linearly with the number of drives added to the data processing device. This was not a desirable effect for those who had to manage the disk drives.

The introduction of Redundant Array of Independent Disks (RAID) technology where algorithms were introduced that generated redundant data that needed to be stored on the disk drives and also allowed a data set to span more than one drive. The redundant data meant that if one drive failed, the data in the data set could be reconstructed from the other drives and the redundant data. RAID increased the availability of the data. Allowing data sets to span more than one drive significantly improved the I/O performance delivered to the data processing device when accessing that data set. The problem with running the RAID algorithms on the data processing device was that it required significant amounts of the data processing device's processing cycles to generate the redundant data and manage the disk drives.

Storage controllers were introduced to solve the existing problems with having disk devices directly connected to data processing devices. The storage controller would make some number of disk drives appear as one large virtual disk drive. This significantly decreased the amount of effort to manage the disk drives. For example, if ten disk drives connected to a storage controller were added to the data processing device then it could appear as one virtual disk. The storage controller would run the RAID algorithms and generate the redundant data thus off loading the data processing device from this task. The storage controller would also add features like caching to improve the I/O performance for some workloads.

Today, most storage controllers are implemented using off the shelf RISC or CISC processors running a commodity operating system like Linux or Windows. There are several problems with this approach. RISC and CISC processors running commodity operating systems do not run storage processing algorithms efficiently. The RAID 5 parity calculation can use up a lot of the processors capacity although some modem storage controllers have special hardware to do the RAID 5 parity calculation. The performance of most if not all RISC and CISC processor solutions tend to bottleneck on the system bus since they suffer from the in/out problem. That is data that comes from the data processing device to the storage controller, through an I/O controller, goes across the system bus to main memory. Eventually the data must be written to the storage media so it goes from the main memory across the system bus to the I/O controller that then sends it to the storage device. The data may even make more trips across the system bus depending on how the RAID 5 parity is calculated, or how a RAID 1 device initiates the mirrored write to 2 different disk drives. Data that goes out of the storage controller comes to the I/O controller and is then sent across the system bus to main memory. Eventually the data goes from main memory across the system bus to an I/O controller that sends it to the data processing device. This problem gets worse for storage controllers as the disk drives become faster. The overall problem is that the storage controller tends to bottleneck on the system bus and/or the RISC or CISC processor. Some vendors have tried to fix this problem by having separate busses for data and control information (LSI Storage Controllers). For these cases the RISC or CISC processor becomes the sole bottleneck.

Some vendors have built custom Application Specific Integrated Circuits (ASIC) to do specialized storage tasks. The ASICs typically have much higher performance than the RISC or CISC processors. The downside to using ASICs is that they take a lot of time to create and are generally inflexible. Using ASICs can negatively impact time-to-market for a product. They lack the flexibility of RISC and CISC processors.

Another problem with modem storage controllers is that they typically use commodity off the shelve host-bus adapters, or the chips used on these adaptors, that connect physical Storage Area Networks (SAN) and/or Local Area Networks (LAN) to the storage controllers. Internally they use these chips to indirectly connect the RISC or CISC processor and system memory to the disk drives. These host-bus adapter cards and chips can be expensive and add a lot of cost to the storage controllers.

To summarize, the problems with modem storage controllers include the following issues. They use RISC and CISC processors that are not optimized for moving data around and simultaneously processing the data. The architecture imposed by using RISC and CISC style processors leads to the “in and out” problem that causes the same data to move across the system busses several times. ASICs are sometimes used to speed up portions of the storage controller. It takes longer to bring a custom ASIC to the market than to create a software program to do the same thing on a RISC or CISC processor. They require expensive host-bus adaptor cards that are not flexible in supporting multiple physical layer protocols used by storage controllers. Commodity operating systems running on CISC or RISC processors do not process protocols efficiently.

Almost every field of human endeavor has benefited from applying computers to the field. Computers are used for modeling and simulating scientific and engineering problems, diagnosing medical conditions, controlling industrial equipment, forecasting the weather, managing stock portfolios, and many other purposes. Computing started out by running a program on a single computer. The single computer was made faster to run the program faster but the amount of computing power available to run the program was whatever the single computer could deliver. Clustered computing introduced the idea of coupling two or more computers to run the program faster than could be done on a single computer. This approach worked well when clustering a few computers together but did not work well when coupling hundreds of computers together. Communication overhead and cluster management were issues in larger configurations. In the early days clustered computers were tightly coupled, that is the computers had to be physically close together, typically within a few feet of each other. The concept of Distributed Computing became popular in the 1980s and loosely coupled clusters of computers were created. The computers could be spread out geographically.

To summarize, the problems with modem compute elements include the following issues. Software programs had to be modified to take advantage of clustered or distributed computing. There were few standards so that programs would not run well on different operating systems or computing systems. Communication overhead was always a problem. That is keeping the compute processors supplied with data to process is an issue. As computer processors get faster and faster, a reoccurring problem is that they have to wait for the data to arrive for processing. The data typically come from a computer network where the date is stored on a network storage device. Today, most computer processors are off the shelve RISC or CISC processors running a commodity operating system like Linux or Windows. There are several problems with this approach. RISC and CISC processors running commodity operating systems do not run protocol-processing algorithms efficiently. That means getting the data from or sending the data to the computer network is done inefficiently.

### SUMMARY OF THE INVENTION

The present invention relates to an apparatus and methods for performing these operations. The apparatus preferably comprises specially constructed computing hardware as described herein. It should be realized that there are numerous ways to instantiate the computing hardware using any of the network processors available today or in the future. The algorithms presented herein are specifically designed for execution on a network processor.

The detailed description that follows is presented largely in terms of algorithms and symbolic representations of operations on data bits and data structures within a computer, and/or network processor memory. These algorithmic descriptions and representations are the means used by those skilled in the data processing arts to most effectively convey the substance of their work to others skilled in the art.

An algorithm is here, and generally, conceived to be a self-consistent sequence of steps leading to a desired result. These steps are those requiring physical manipulation of physical quantities. Usually, though not necessarily, these quantities take the form of electrical, optical, or magnetic signals capable of being stored, transferred, combined, compared, and otherwise manipulated. It proves convenient at times, principally for reasons of common usage, to refer to these signals as bit patterns, values, elements, symbols, characters, data packages, packets, or the like. It should be borne in mind, however, that all of these and similar terms are to be associated with the appropriate physical quantities and are merely convenient labels applied to these quantities.

Further, the manipulations performed are often referred to in terms, such as adding or comparing, that are commonly associated with mental operations performed by a human operator. No such capability of a human operator is necessary, or desirable in most cases, in any of the operations described herein that form part of the present invention; the operations are machine operations. Useful machines for performing the operations of the present invention include devices that contain network processors. In all cases there should be borne in the mind the distinction between the method of operations in operating a computer and the method of the computation itself. The present invention relates to method steps for operating a computer in processing electrical or other (e.g. mechanical, chemical, optical) physical signals to generate other desired physical signals.

### BRIEF DESCRIPTION OF THE DRAWINGS

FIG. 1 illustrates a network environment employing the present invention.

FIG. 2 illustrates a direct attached storage environment employing the present invention.

FIG. 3 illustrates the preferred embodiment of the apparatus of the present invention.

FIG. 4 illustrates how data would be stored going straight to the storage media using the present invention.

FIG. 5 illustrates how data would be stored going through the buffer cache and then to the storage media using the present invention.

FIG. 6 illustrates how data would be retrieved straight from the storage media using the present invention.

FIG. 7 illustrates how data would be retrieved from the storage media through the buffer cache using the present invention.

FIG. 8 illustrates a network environment employing the present invention.

FIG. 9 illustrates the preferred embodiment of the apparatus of the present invention.

FIG. 10 illustrates a request by the host CPU for data from the network to be loaded into the host CPU memory using the present invention.

FIG. 11 illustrates a request by the host CPU for data from the host CPU memory to be transferred to the network using the present invention.

### DETAILED DESCRIPTION OF THE INVENTION

The present invention is of an apparatus and method for a network processor-based storage controller provides storage services to data processing devices which has particular application to providing storage services to data processing devices in a network of computers, and/or Directly Attached Storage (DAS). In the following description for purposes of explanation, specific applications, numbers, materials and configurations are set forth in order to provide a thorough understanding of the present invention. However, it will be apparent to one skilled in the art that the present invention may be practiced without the specific details. In other instances, well-known systems are shown in diagrammatical or block diagram form in order not to obscure the present invention unnecessarily.

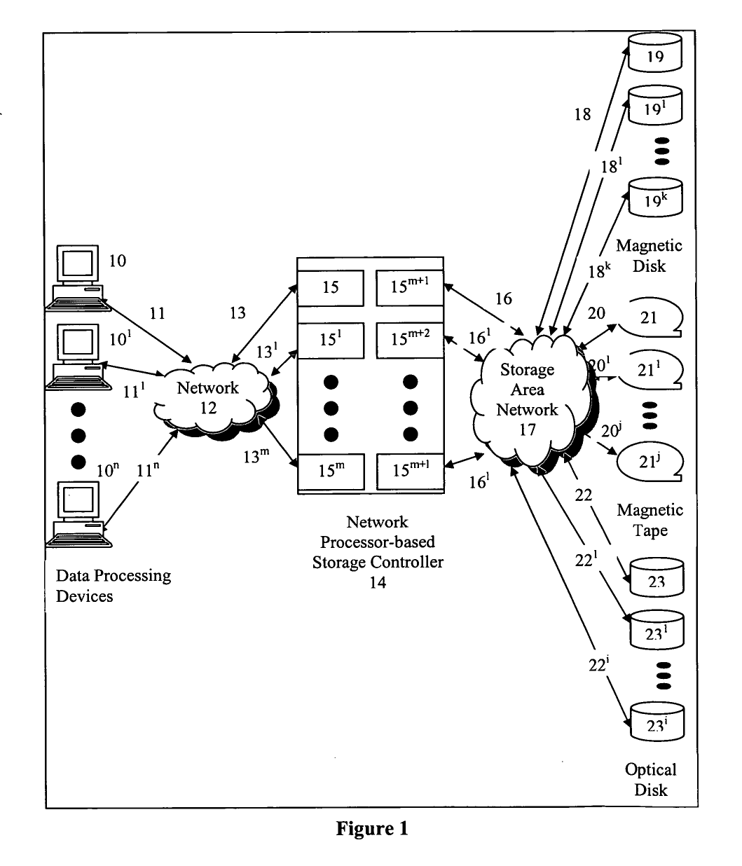

Referring to FIG. 1, a computer network environment comprises a plurality of data processing devices identified generally by numerals 10 through 10ⁿ (illustrated as 10, 10¹ and 10ⁿ). These data processing devices may include terminals, personal computers, workstations, minicomputers, mainframes, and even supercomputers. For the purpose of this Specification, all data processing devices that are coupled to the present invention's network are collectively referred to as “clients” or “hosts”. It should be understood that the clients and hosts may be manufactured by different vendors and may also use different operating systems such as Windows, UNIX, Linux, OS/2, MAC OS and others. As shown, clients 10 through 10ⁿ (illustrated as 10, 10¹ and 10ⁿ) are interconnected for data transfer to one another or to other devices on the network 12 through a connection identified generally by numerals 11 through 11ⁿ (illustrated as 11, 11¹ and 11ⁿ). It will be appreciated by one skilled in the art that the connections 11 through 11ⁿ (illustrated as 11, 11¹ and 11ⁿ) may comprise any shared media, such as twisted pair wire, coaxial cable, fiber optics, radio channel and the like. Although only one connection from a client to the network 12 is shown, each client could have multiple connections to the network 12. Furthermore, the network 12 resulting from the connections 11 through 11ⁿ (illustrated as 11, 11¹ and 11ⁿ) and the clients 10 through 10ⁿ (illustrated as 10, 10¹ and 10ⁿ) may assume a variety of topologies, such as ring, star, bus, and may also include a collection of smaller networks linked by gateways, routers, or bridges.

Referring again to FIG. 1 is a Network Processor-based Storage Controller 14. The Network Processor-based Storage Controller 14 provides similar functionality as a CISC or RISC-based storage controller. The Network Processor-based Storage Controller 14 manages storage devices such as magnetic disk drives 19 through 19^{k} (illustrated as 19, 19¹ and 19^{k}), magnetic tape drives 21 through 21^{j} (illustrated as 21, 21¹ and 21^{j}), optical disk drives 23 through 23ⁱ (illustrated as 23, 23¹ and 23ⁱ), and any other type of storage medium that a person may want to use. The storage devices could be used by themselves, but more commonly, they are aggregated into a chassis. For example, the magnetic disk drives 19 through 19^{k} (illustrated as 19, 19¹ and 19^{k}) could be placed inside a disk array enclosure commonly referred to as Just a Bunch of Disks (JBOD). The magnetic tape drives 21 through 21^{j} (illustrated as 21, 21¹ and 21^{j}) could be placed inside a tape jukebox that holds hundreds or thousands of tapes and has several tape drives. A robotic mechanism puts the desired tape into a tape drive. Similarly, optical disk drives 23 through 23ⁱ (illustrated as 23, 23¹ and 23ⁱ) could be placed inside an optical disk drive that works like a tape jukebox. In addition, traditional storage controllers could be connected to the storage area network 17 and be used and managed by the Network Processor-based Storage Controller 14.

Referring again to FIG. 1 the Network Processor-based Storage Controller 14 manages the above mentioned storage devices for the clients. The storage management functions include but are not limited to data storage and retrieval, data backup, providing data availability that is providing data even when there are hardware failures within the storage controller, providing access control to the data, provisioning, prioritizing access to the data, and other tasks that are part of storage management. The Network Processor-based Storage Controller 14 is connected to the above mentioned storage devices through a Storage Area Network (SAN) 17. The Network Processor-based Storage Controller is connected to the storage area network through connections 16 through 16^{l} (superscript letter 1) (illustrated as 16, 16¹ and 16^{l}). The only difference between the network 12 and the storage area network 17 is that only storage devices are connected to the storage area network 17 where as storage devices and data processing devices are connected to network 17. The connections 18 through 18^{k} (illustrated as 18, 18^{and 18}^{k}) connect the magnetic disks 19 through 19^{k} (illustrated as 19, 19¹ and 19^{k}) to the storage area network 17. The connections 20 through 20^{j} (illustrated as 20, 20¹ and 20^{j}) connect the magnetic tape 21 through 21^{j} (illustrated as 21, 21¹ and 21^{j}) to the storage area network 17. The connections 22 through 22ⁱ (illustrated as 22, 22¹ and 22ⁱ) connect the optical disks 23 through 23ⁱ (illustrated as 23, 23¹ and 23ⁱ) to the storage area network 17. It will be appreciated by one skilled in the art that the connections 16 through 16¹ (illustrated as 16, 16¹ and 16¹), the connections 18 through 18^{k} (illustrated as 18, 18¹ and 18^{k}), the connections 20 through 20^{j} (illustrated as 20, 20¹ and 20^{j}), and the connections 22 through 22ⁱ (illustrated as 22, 22¹ and 22^{j}) may comprise any shared media, such as twisted pair wire, coaxial cable, fiber optics, radio channel and the like. It is important to note that some storage devices are multi-ported, that means they support more than one connection to the storage area network. FIG. 1 does not show a multi-ported storage device, but the present invention can easily support without modification multi-ported storage devices.

Referring again to FIG. 1, the Network Processor-based Storage Controller 14 is connected to the same network 12 that the clients are. The Network Processor-based Storage Controller 14 is connected to network 12 through connections 13 through 13^{m} (illustrated as 13, 13¹ and 13^{m}). This connection approach is referred to as Network Storage. It will be appreciated by one skilled in the art that the connections 13 through 13^{m} (illustrated as 13, 13¹ and 13^{m}) may comprise any shared media, such as twisted pair wire, coaxial cable, fiber optics, radio channel and the like.

Referring again to FIG. 1, the Network Processor-based Storage Controller 14 is connected to both the network 12 and the storage area network 17 through the I/O connections numbered 15 through 15^{m+1} (illustrated as 15, 15¹ and 15^{m+1}). The I/O connections numbered 15 through 15^{m} (illustrated as 15, 15¹ and 15^{m}) are called client-side or host-side connections and in this figure are connected to the network 12. The I/O connections numbered 15^{m+1} through 15^{m+1} (illustrated as 15^{m+1}, 15^{m+2} and 15^{m+1}) are called storage-side connections and in this figure are connected to the storage area network 17. The present invention is flexible with respect to allocating I/O connections to client-side or storage-side connections and a client-side connection can be changed to a storage-side connection on the fly, similarly a storage-side connection could be switched over to a client-side connection on the fly. The storage controller is configured for maximizing through put when the number of client side connections is greater than the number of storage side connections, that is m>l (letter l). The storage controller is configured for maximizing I/Os per second when the number of client side connections is less than the number of storage side connections, that is m<l (letter l). The storage controller is configured for balanced performance when the number of client side connections is equal to the number of storage side connections, that is m=l (letter l). Each I/O connection numbered 15 through 15^{m+1} (illustrated as 15, 15¹ and 15^{m+1}) could be using a different physical media (e.g. Fibre Channel, Ethernet) or they could be using the same type of physical media.

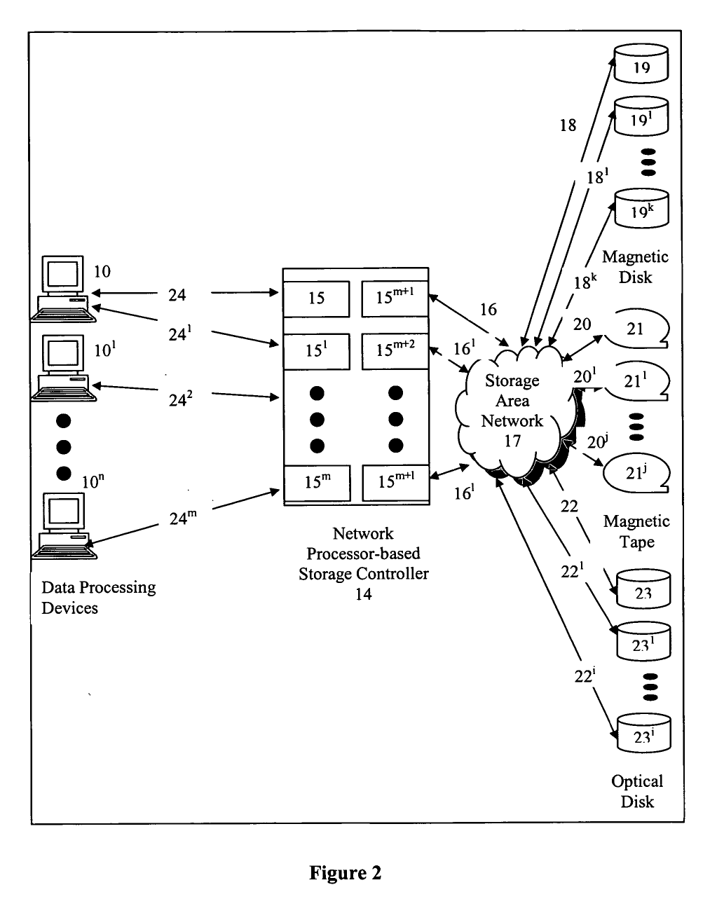

FIG. 2 is similar to FIG. 1. Referring to FIG. 2, the difference is how the clients 10 through ion (illustrated as 10, 10¹ and 10ⁿ) are hooked up to the Network Processor-based Storage Controller 14. Connections 24 through 24^{m} (illustrated as 24, 24¹, 24² and 24^{m}) connect the client directly to the Network Processor-based Storage Controller 14. There can be more than one connection from a single client to the Network Processor-based Storage Controller 14 as shown with connections 24¹ and 24². This type of connection approach is referred to as Direct Attach Storage (DAS). It will be appreciated by one skilled in the art that the connections 24 through 24^{m} (illustrated as 24, 24¹, 24² and 24^{m}) may comprise any shared media, such as twisted pair wire, coaxial cable, fiber optics, radio channel and the like.

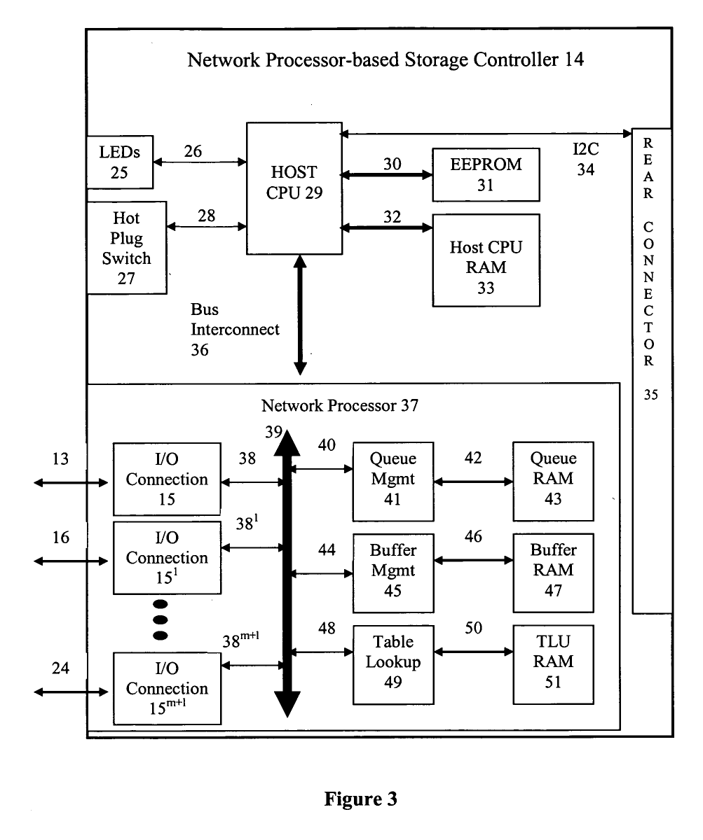

Referring to FIG. 3 is a block diagram of the Network Processor-based Storage Controller 14 hardware. The network processor 37 could consist of one or more computer chips from different vendors (e.g. Motorola, Intel, AMCC). A network processor is typically created from several RISC core processors that are combined with packet processing state machines. A network processor is designed to process network packets at wire speeds and allow complete programmability that provides for fast implementation of storage functionality. The network processor 37 has I/O connections numbered 15 through 15^{m+1} (illustrated as 15, 15¹ and 15^{m+1}). The I/O connections can have processors built into them to serialize and deserialize a data stream which means that the present invention can handle any serialized storage protocol such as iSCSI, Serial SCSI, Serial ATA, Fibre Channel, or any Network-based protocol. The I/O connection processors are also capable of pre-processing or post-processing data as it is coming into or going out of the Network Processor-based Storage Controller 14. These I/O connections can be connected to a network 12 through connection 13, a storage area network 17 through connection 16, or directly to the client 10 through 10ⁿ (illustrated as 10, 10¹ and 10ⁿ) through connection 24. Each I/O connection can support multiple physical protocols such as Fibre Channel or Ethernet. In other words I/O Connection 15 could have just as easily been connected to a storage area network 17 through connection 16. The network processor 37 contains one or more internal busses 39 that move data between the different components inside the network processor. These components consist of, but are not limited to, The I/O Connections numbered 15 through 15^{m+1} (illustrated as 15, 15¹ and 15^{m+1}) which are connected to the internal busses 39 through connections numbered 38 through 38^{m+1} (illustrated as 38, 38¹ and 38^{m+1}); a Buffer Management Unit 45 which is connected to the internal busses 39 through connection 44; a Queue Management Unit 41 which is connected to the internal busses 39 through connection 40; and a Table Lookup Unit (TLU) 49 which is connected to the internal busses 39 through connection 48. The Buffer Management Unit 45 buffers data between the client and storage devices. The Buffer Management Unit 45 is connected to Buffer Random Access Memory 47 (RAM) through connection 46 which can be any type of memory bus. The Buffer RAM 47 can also be used as a storage cache to improve the performance of writes and reads from the clients. The Queue Management Unit 41 provides queuing services to all the components within the Network Processor 37. The queuing services include, but are not limited to, prioritization, providing one or more queues per I/O Connection numbered 15 through 15^{m+1} (illustrated as 15, 15¹ and 15^{m+1}), and multicast capabilities. The data types en-queued are either a buffer descriptor that references a buffer in Buffer RAM 47 or a software-defined inter-processor unit message. The Queue Management Unit 41 is connected to the Queue RAM 43 through connection 42 which can be any type of memory bus. During a data transfer a packet may be copied into the Buffer RAM 47, after this happens the component that initiated the copy will store a queue descriptor with the Queue Management Unit 41 that will get stored in the appropriate queue in the Queue RAM 47. When a component de-queues an item it is removed from the appropriate queue in the Queue RAM 47. The TLU 49 is connected to the TLU RAM 51 through connection 50 which can be any type of memory bus. The TLU 49 manages the tables that let the Network Processor-based Storage Controller 14 know which storage device to write data from the client, which storage device to read data from to satisfy a request from a client, whether to satisfy a request from the Buffer Management RAM 47, or whether to do cut-through routing on the request, or whether to send the request to the Host CPU 29 for processing. The tables can be used to manage the storage cache in the Buffer RAM 47 through the Buffer Management Unit 45.

Referring again to FIG. 3, the Host CPU 29 handles storage management features for the Network Processor-based Storage Controller 14. The Host CPU 29 is connected to the Network Processor 37 by connection 36 which is a standard Bus Connection used to connect computing devices together (e.g. PCI, PCI-X, Rapid I/O). Storage features that do not have performance critical requirements will be run on the Host CPU 29. Examples of non-performance critical features are the storage management functions which consist of, but are not limited to, WEB-based User Interface, Simple Network Management Protocol processing, Network Processor Table Management, and other ancillary services that are expected of a storage server. The Host CPU 29 runs a real-time or embedded operating system such as VxWorks or Linux. The Host CPU 29 is connected to the Host CPU RAM 33 through connection 32 which can be any type of memory bus. The Host CPU 29 is connected to a Electrically Erasable Programmable Read Only Memory (EEPROM) 31 through connection 30 which can be any type of memory bus. The EEPROM 31 could consist of one or more devices. The EEPROM 31 contains the firmware for the entire Network Processor-based Storage Controller 14 and is loaded by the Host CPU 29 after power is turned on. The Host CPU 29 can update the EEPROM 31 image at any time. This feature allows the Network Processor-based Storage Controller 14 firmware to be dynamically upgradeable. The EEPROM 31 also holds state for the storage controller, such as disk configurations, which are read from the EEPROM 31 when the Network Processor-based storage controller 14 is powered on. Status LEDs 25 are connected to the Host CPU 29 over a serial or I2C connection 26. The status LEDs indicate the current status of the storage controller such as operational status, and/or data accesses in progress. The Hot Plug Switch 27 is connected to the Host CPU 29 over a serial or I2C connection 28. The Hot Plug Switch 27 allows the Network Processor-based Storage Controller 14 board to be added or removed from a chassis even though chassis power is on. The Network Processor-based Storage Controller 14 has a Rear Connector 35 that connects to a chassis allowing several controllers to be grouped together in one chassis. The Rear Connector 35 has an I2C connection 34 that allows the Host CPU 29 to report or monitor environmental status information, and to report or obtain information from the chassis front panel module.

Referring again to FIG. 3, the Network Processor-based Storage Controller 14 could also have additional special purpose hardware not shown in FIG. 3. This hardware could accelerate data encryption operations, data compression operations, and/or XOR calculations used by RAID 5 storage functionality. This hardware is added to the invention as needed. Adding the hardware increases performance but also increases the cost.

It is important to note that a network processor is optimized for moving data. The present invention allows the combination of a storage controller with a communications switch to create a functional switch where storage services are the functions being performed by the switch. Processing of the data packet takes place along the way or after a packet has been queued. The present invention combines the traditional storage controller with the SAN appliance to create a switched storage controller that can scale beyond a single controller. The disk array weakness is overcome by implementing scalability features. The SAN appliance weakness is overcome because our server runs the volume management and has direct control over the data. We are not adding another device into the path of the data because the disk array and SAN appliance are merged.

The present invention can support most storage access protocols. More specifically it can handle Network Attached Storage protocols such as the Network File System (NFS) or the Common Internet File System (CIFS), it can support Network Storage protocols such as SCSI, iSCSI, Fibre Channel, Serial ATA, and Serial SCSI.

It is important to note that nothing in the present invention prevents the aggregation of N number of Network Processor-based Storage Controllers into a single virtual storage controller. This is a separate invention covered in another patent application by the inventor.

The rest of the discussion will present examples of how the present invention would store or retrieve data. No error handling is shown in the figures or discussion but is performed by the present invention.

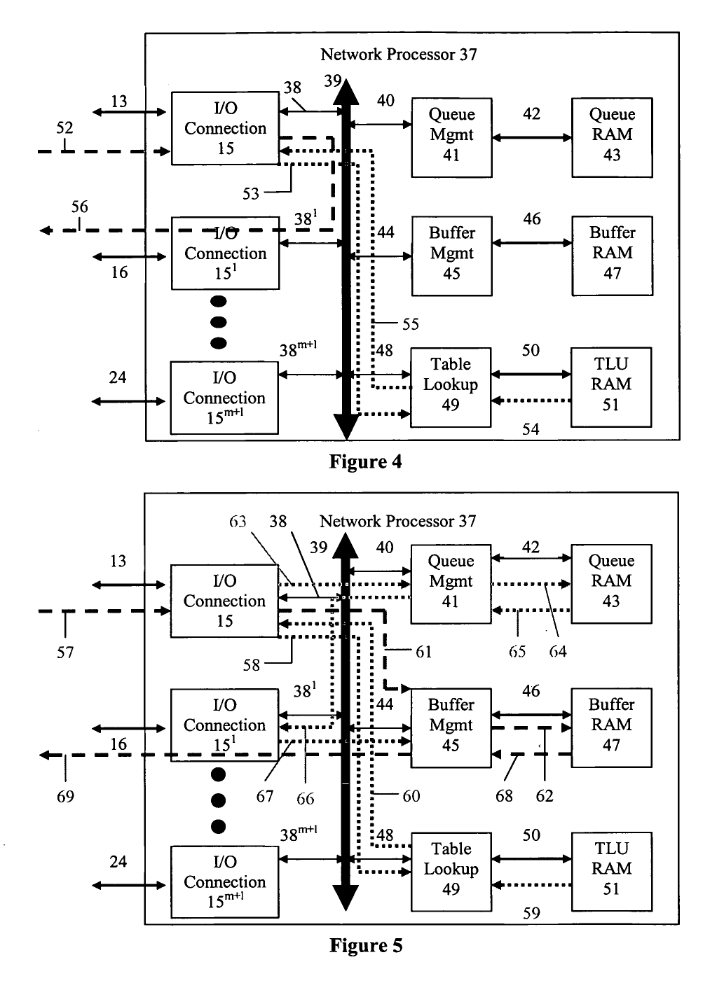

Referring to FIG. 4 is an illustration of how a request to write a data packet, coming from the Network 12 through connection 13, would travel through the Network Processor 37 and end up being stored on storage media in the SAN network 17 through connection 16. For this example, the Network Processor 37 is not queuing the data packet but using cut-through routing to the storage media. Also for this example, the write request and the data to be written are in the same packet, which is not a requirement of the present invention. The data packet coming in is shown by arrow 52. As I/O Connection 15 starts receiving the start of the data packet, but not the entire data packet, it will collect the bits until it has enough to do a table lookup to determine what to do with the incoming packet. Arrow 53 shows the table lookup request going from I/O Connection 15 across bus connection 38 through the system busses 39 and then through bus connection 48 to the TLU 49. The TLU 49 will perform a table lookup searching the information in the TLU RAM 51 that results in reads of the TLU RAM 51 as shown by arrow 54. The TLU 49 will either return actions if the actions for processing that type of data packet are in the table, or an indication that no actions were found. Arrow 55 shows the action information being returned from the TLU 49 through bus connection 48 through the system busses 39 and then through bus connection 38 to I/O Connection 15. If no actions were returned then the packet would be forwarded to the Host CPU 29 (FIG. 3) to determine how to process the packet. This is not shown in FIG. 4. Assuming that the TLU 49 returned actions to the I/O Connection 15 through arrow 55 indicating that the packet needs to be sent directly to the storage media. The action information returned would include information for addressing the packet to the proper storage media. Typically before all the data from the packet has arrived at the I/O Connection 15, it will receive the action information from the TLU 49. For this example, it will modify the packet header so that it is addressed to the specified storage media and then the I/O Connection 15 will start transferring the packet over bus connection 38 through system busses 39 and then through bus connection 38¹ to I/O Connection 15¹ for transmission over connection 16 as shown by arrow 56. Note that this example assumes that I/O Connection 15¹ was idle and ready to transmit a packet. Had I/O connection 15¹ not been idle, I/O connection 15 would have had to in queue the request which is not shown in this example but will be shown in FIG. 5. FIG. 4 does not show the reply that would come back to the storage media through I/O connection 15¹ and be routed to I/O connection 15 where it would be turned in to a reply for the client letting the client know that the write succeeded.

Referring to FIG. 5 is an illustration of how a request to write a data packet, coming from the Network 12 through connection 13, would travel through the Network Processor 37 and end up being stored on storage media in the SAN network 17 through connection 16. For this example, the Network Processor 37 is queuing the data packet. Incoming writes would be queued if they required further processing, needed to be cached for performance, or were being routed to an I/O connection that was busy. Also for this example, the write request and the data to be written are in the same packet, which is not a requirement of the present invention. The data packet coming in is shown by arrow 57. As I/O Connection 15 starts receiving the start of the data packet, but not the entire data packet, it will collect the bits until it has enough to do a table lookup to determine what to do with the incoming packet. Arrow 58 shows the table lookup request going from I/O Connection 15 across bus connection 38 through the system busses 39 and then through bus connection 48 to the TLU 49. The TLU 49 will perform the table lookup searching the information in the TLU RAM 51 that results in reads of the TLU RAM 51 as shown by arrow 59. The TLU 49 will either return actions if the actions for processing that type of data packet are in the table, or an indication that no actions were found. Arrow 60 shows the action information being returned from the TLU 49 through bus connection 48 through the system busses 39 and then through bus connection 38 to I/O Connection 15. If no actions were returned then the packet would be forwarded to the Host CPU 29 (FIG. 3) to determine how to process the packet. This is not shown in FIG. 5. Assuming that the TLU 49 returned actions to the I/O Connection 15 through arrow 60 indicating that the packet needs to be queued before being sent to the storage media, The action information returned would include information for addressing the packet to the proper storage media. Typically before all the data from the packet has arrived at the I/O Connection 15, it will receive the action information from the TLU 49. For this example, it will modify the packet header so that it is addressed to the specified storage media and then the I/O Connection 15 will start transferring the packet over bus connection 38 through system busses 39 and over bus connection 44 to the Buffer Management Unit 45 as shown by arrow 61. The Buffer Management Unit 45 will write the packet to the Buffer RAM 47 as shown by arrow 62. When the transfer is complete, I/O Connection 15 will send a queue entry over bus connection 38 through system busses 39 and across bus connection 40 to the Queue Management Unit 41 as shown by arrow 63. The queue entry contains a pointer to the buffered packet in the Buffer Management Unit 45 and a reference to the I/O Connection that is suppose to transmit the packet. The Queue Management Unit 41 will store the queue entry in Queue RAM 43 as shown by arrow 64. When the Queue Management Unit 41 determines that it is time to de-queue the entry then it will read Queue RAM 43 as shown by arrow 65. The Queue Management Unit 41 will then send a message over bus connection 40 through system busses 39 and over bus connection 38¹ telling I/O Connection 15¹ to transmit the packet. This path is shown by arrow 66. I/O Connection 15¹ will send a request for the buffer over bus connection 38¹ through system busses 39 and over bus connection 44 to the Buffer Management Unit 45 as shown by arrow 67. The Buffer Management Unit 45 will read the packet from Buffer RAM 47 as shown by arrow 68 and send it to over bus connection 44 through system busses 39 and over bus connection 38¹ to I/O Connection 15¹ as shown by arrow 69. I/O Connection 15¹ will transmit the packet to the SAN 17 over connection 16 as also shown by arrow 69. FIG. 5 does not show the reply that would come back to the storage media through I/O connection 15¹ and be routed to I/O connection 15 where it would be turned in to a reply for the client letting the client know that the write succeeded. If the data packet coming in as shown by arrow 57 were to be cached then I/O connection 15 would send a reply to the client letting the client know that the write succeeded. For this case the Buffer RAM 47 would need to be consistent memory. This is typically achieved by connecting the Network Processor-based Storage Controller 14 to a battery-backed power supply.

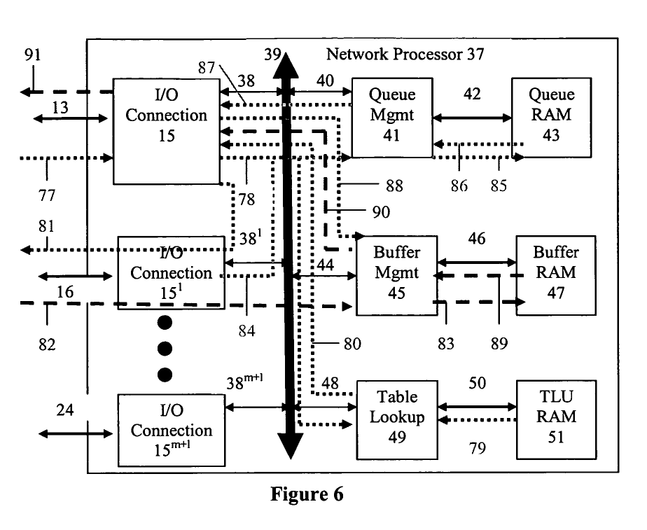

Referring to FIG. 6 is an illustration of how a request to read data, coming from the Network 12 through connection 13, would travel through the Network Processor 37 and end up being read from the storage media in the SAN network 17 through connection 16. For this example, the Network Processor 37 is not queuing the data packet read but using cut-through routing from the storage media to the client. Also for this example, the read request and the data read are not in the same packet. The read request comes from the Network 12 over connection 13 to I/O Connection 15 as shown by arrow 70. As I/O Connection 15 starts receiving the start of the data packet, but not the entire data packet, it will collect the bits until it has enough to do a table lookup to determine what to do with the incoming packet. Arrow 71 shows the table lookup request going from I/O Connection 15 across bus connection 38 through the system busses 39 and then through bus connection 48 to the TLU 49. The TLU 49 will perform the table lookup searching the information in the TLU RAM 51 that results in reads of the TLU RAM 51 as shown by arrow 72. 46 The TLU 49 will either return actions if the actions for processing that type of data packet are in the table, or an indication that no actions were found. Arrow 73 shows the action information being returned from the TLU 49 through bus connection 48 through the system busses 39 and then through bus connection 38 to I/O Connection 15. If no actions were returned then the packet would be forwarded to the Host CPU 29 (FIG. 3) to determine how to process the packet. This is not shown in FIG. 6. Assuming that the TLU 49 returned actions to the I/O Connection 15 through arrow 73 indicating that the packet needs to be queued before being sent to the storage media, the action information returned would include information for addressing the packet to the proper storage media. Typically before all the data from the packet has arrived at the I/O Connection 15, it will receive the action information from the TLU 49. For this example, it will contain information on where the data requested is stored. I/O Connection 15 will start transferring the request for data to the storage media. The request will be transferred from I/O Connection 15 over bus connection 38 through system busses 39 and over bus connection 38¹ to I/O connection 15¹, which is assumed to be idle. The request is shown by arrow 74 and goes to the SAN 17 over connection 16. The storage media will then return the data through the SAN 17 over connection 16 as shown by arrow 75. I/O Connection 15¹ will cut-through route the data over bus connection 381 through system busses 39 and over bus connection 38 to I/O Connection 15 where the packet header will be modified so that the data will be sent to the client through Network 12 over connection 13 as shown by arrow 76.

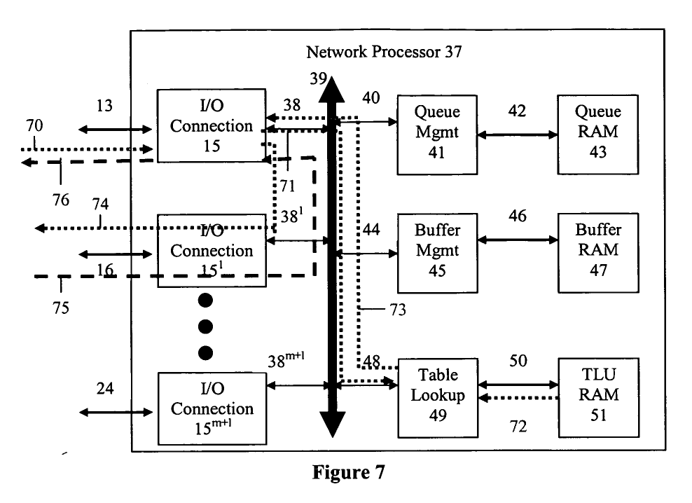

Referring to FIG. 7 is an illustration of how a request to read data, coming from the Network 12 through connection 13, would travel through the Network Processor 37 and end up being read from the storage media in the SAN network 17 through connection 16. For this example, the Network Processor 37 is queuing the data packet. Also for this example, the read request and the data read are not in the same packet. The read request comes from the Network 12 over connection 13 to I/O Connection 15 as shown by arrow 77. As I/O Connection 15 starts receiving the start of the data packet, but not the entire data packet, it will collect the bits until it has enough to do a table lookup to determine what to do with the incoming packet. Arrow 78 shows the table lookup request going from I/O Connection 15 across bus connection 38 through the system busses 39 and then through bus connection 48 to the TLU 49. The TLU 49 will perform the table lookup searching the information in the TLU RAM 51 that results in reads of the TLU RAM 51 as shown by arrow 79. The TLU 49 will either return actions if the actions for processing that type of data packet are in the table, or an indication that no actions were found. Arrow 80 shows the action information being returned from the TLU 49 through bus connection 48 over the system busses 39 and then through bus connection 38 to I/O Connection 15. If no actions were returned then the packet would be forwarded to the Host CPU 29 (FIG. 3) to determine how to process the packet. This is not shown in FIG. 7. Assuming that the TLU 49 returned actions to the I/O Connection 15 through arrow 80 indicating that the packet needs to be queued before being sent to the read requester, the action information returned would include information for addressing the packet to the proper storage media. Typically before all the data from the packet has arrived at the I/O Connection 15, it will receive the action information from the TLU 49. For this example, it will contain information on where the data requested is stored. I/O Connection 15 will start transferring the request for data to the storage media. The request will be transferred through bus connection 38 over system busses 39 and through bus connection 381 to I/O connection 151, which is assumed to be idle. The request is shown by arrow 81 and goes to the SAN 17 over connection 16. The storage media will then return the data through the SAN 17 over connection 16 as shown by arrow 82. I/O Connection 15¹ will send the packet over bus connection 38¹ through system busses 39 and over connection 44 to the Buffer Management Unit 45 also shown by arrow 82. The Buffer Management Unit 45 will store the packet in the Buffer RAM 47 as shown by arrow 83. When the transfer is complete, I/O Connection 15¹ will send a queue entry over bus connection 38¹ through system busses 39 and over bus connection 40 to the Queue Management Unit 41 as shown by arrow 84. The queue entry contains a pointer to the buffered packet in the Buffer Management Unit 45 and a reference to the I/O Connection that is suppose to transmit the packet. The Queue Management Unit 41 will store the queue entry in Queue RAM 43 as shown by arrow 85. When the Queue Management Unit 41 determines that it is time to de-queue the entry then it will read Queue RAM 43 as shown by arrow 86. The Queue Management Unit 41 will then send a message over bus connection 40 through system busses 39 and over bus connection 38 to tell I/O Connection 15 to transmit the packet as shown by arrow 87. I/O Connection 15 will send a request for the buffer over bus connection 38 through system busses 39 and over bus connection 44 to the Buffer Management Unit 45 as shown by arrow 88. The Buffer Management Unit 45 will read the packet from Buffer RAM 47 as shown by arrow 89 and send it over bus connection 44 through system busses 39 and over bus connection 38 to I/O Connection 15 as shown by arrow 90. I/O Connection 15 will transmit the packet to the SAN 17 over connection 16 as shown by arrow 91.

The invention is also of an apparatus and method for a Network Processor-based Compute Element that provides computing services which has particular application to providing computing services in a networking environment.

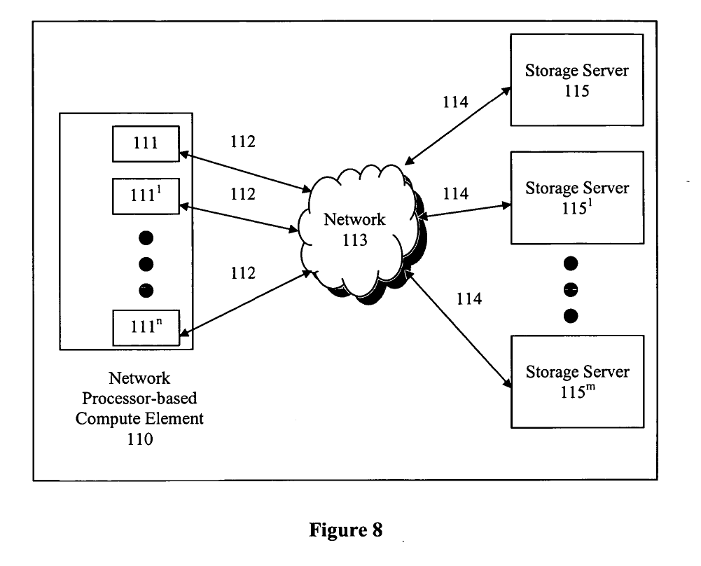

Referring to FIG. 8, a computer network environment comprises a plurality of Network Processor-based Compute Elements identified generally by numeral 110. Only one Network Processor-based Compute Element 110 is shown although there could be many connected to a computer network and either working together or working independently. The Network Processor-based Compute Element 110 provides similar functionality as a CISC or RISC-based computing device as provided by a computer server, or computational farm often referred to as a computational grid. As shown in FIG. 8, Network Processor-based Compute Element 110 contains I/O connections identified generally by numerals 111 through 111n (illustrated as 111, 111¹ and 111ⁿ). The I/O connections 111 through 111ⁿ (illustrated as 111, 111¹ and 111ⁿ) are connected to a computer network 113 through connections 112 through 112ⁿ (illustrated as 112, 112¹ and 112ⁿ). Each Network Processor-based Compute Element 110 I/O connection 111 through 111ⁿ (illustrated as 111, 111¹ and 111ⁿ) could be using a different physical media (e.g. Fibre Channel, Ethernet) or they could be using the same type of physical media. It will be appreciated by one skilled in the art that the connections numbered 112 through 112ⁿ (illustrated as 112, 112¹ and 112ⁿ) may comprise any shared media, such as twisted pair wire, coaxial cable, fiber optics, radio channel and the like. The network 113 resulting from the connections 112 through 112ⁿ (illustrated as 112, 112¹ and 112ⁿ) and the Network Processor-based Compute Elements 110 may assume a variety of topologies, such as ring, star, bus, and may also include a collection of smaller networks linked by gateways, routers, or bridges.

Referring again to FIG. 8 is a plurality of Storage Servers identified generally by numerals 115 through 115^{m} (illustrated as 115, 115¹ and 115^{m}). The storage servers allow data to be stored and later retrieved, basically providing storage services to computing devices on the network 113. The storage servers numbered 115 through 115^{m} (illustrated as 115, 115¹ and 115^{m}) are connected to the network 113 through connections numbered 114 through 114^{m} (illustrated as 114, 114¹ and 114^{m}). Although only one connection from each Storage Server numbered 115 through 115^{m} (illustrated as 115, 115¹ and 115^{m}) to the network 113 is shown, each storage server could have one or more connections to the network 113. It will be appreciated by one skilled in the art that the connections numbered 112 through 112ⁿ (illustrated as 112, 112¹ and 112ⁿ) may comprise any shared media, such as twisted pair wire, coaxial cable, fiber optics, radio channel and the like.

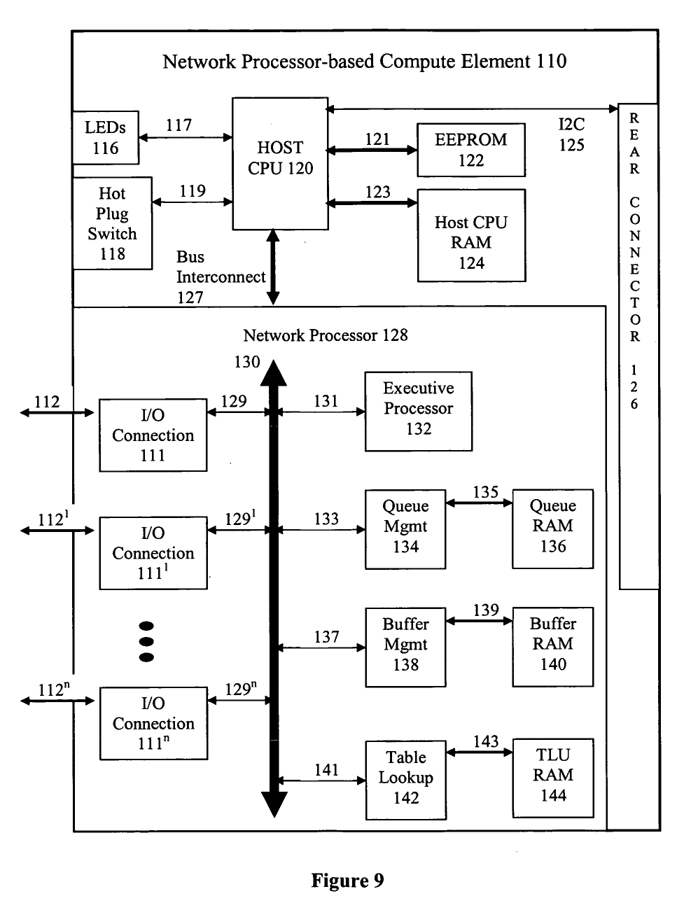

Referring to FIG. 9 is a block diagram of the Network Processor-based Compute Element 110 hardware. The main components are the Network Processor 128 and the Host CPU 120. The network processor 128 gets information from the network storage for the Host CPU 120 to process and the network processor 128 stores the results for the Host CPU 120 on the network storage. The network processor 128 could consist of one or more computer chips from different vendors (e.g. Motorola, Intel, AMCC). A network processor is typically created from several RISC core processors that are combined with packet processing state machines. A network processor is designed to process network packets at wire speeds and allow complete programmability that provides for fast implementation of storage functionality. The network processor has I/O connections numbered 111 through 111ⁿ (illustrated as 111, 111¹ and 111ⁿ). The I/O connections can have processors built into them to serialize and de-serialize a data stream which means that the present invention can handle any serialized storage protocol such as iSCSI, Serial SCSI, Serial ATA, Fibre Channel, or any Network-based protocol. The I/O connection processors are also capable of pre-processing or post-processing data as it is coming into or going out of the Network Processor-based Compute Element 110. These I/O connections can be connected to a network 113 (FIG. 8) through connections numbered 112 through 112ⁿ (illustrated as 112, 112¹ and 112ⁿ). Each I/O connection can support multiple physical protocols such as Fibre Channel or Ethernet. The network processor 128 contains one or more internal busses 130 that move data between the different components inside the network processor 128. These components consist of, but are not limited to, the I/O Connections numbered 111 through 111ⁿ (illustrated as 111, 111¹ and 111ⁿ) which are connected to the internal busses 130 through connections numbered 129 through 129ⁿ (illustrated as 129, 129¹ and 129ⁿ); an Executive Processor 132 which is connected to the internal busses 130 through connection 131; a Buffer Management Unit 138 which is connected to the internal busses 130 through connection 137; a Queue Management Unit 134 which is connected to the internal busses 130 through connection 133; and a Table Lookup Unit (TLU) 142 which is connected to the internal busses 130 through connection 141. The Executive Processor 132 handles all processing of requests from the Host CPU 120, and routes any packets received that an I/O Connection cannot because of a TLU 142 lookup miss. The Buffer Management Unit 138 buffers data between the Host CPU 120 and storage servers numbered 115 through 115^{m} (illustrated as 115, 115¹ and 115^{m}) (FIG. 8). The Buffer Management Unit 138 is connected to Buffer Random Access Memory 140 (RAM) through connection 139 which can be any type of memory bus. The Queue Management Unit 134 provides queuing services to all the components within the Network Processor 128. The queuing services include, but are not limited to, prioritization, providing one or more queues per I/O Connection numbered 111 through 111ⁿ (illustrated as 111, 111¹ and 111ⁿ), and multicast capabilities. The data types en-queued are either a buffer descriptor that references a buffer in Buffer RAM 140 or a software-defined inter-processor unit message. The Queue Management Unit 134 is connected to the Queue RAM 136 through connection 135 which can be any type of memory bus. During a data transfer a packet may be copied into the Buffer RAM 140, after this happens the component that initiated the copy will store a queue descriptor with the Queue Management Unit 134 that will get stored in the appropriate queue in the Queue RAM 136. When a component de-queues an item it is removed from the appropriate queue in the Queue RAM 136. The TLU 142 is connected to the TLU RAM 144 through connection 143 which can be any type of memory bus. The TLU 142 manages the tables that let the Network Processor-based Compute Element 110 know which storage server to write data from the application, which storage server to read data from to satisfy a request from an application, whether to satisfy a request from the Buffer Management RAM 140, or whether to do cut-through routing on the request, or whether to send the request to the Host CPU 120 for processing.

Referring again to FIG. 9, the Host CPU 120 is connected to the Network Processor 128 by connection 127 which is a standard Bus Connection used to connect computing devices together (e.g. PCI, PCI-X, Rapid I/O). The Host CPU 120 performs all the computing functions for the Network Processor-based Compute Element 110. The Host CPU could provide compute services to a Grid Computer or it could perform the functions of a compute server. It can perform any functions that a typical computer could perform. The Host CPU 120 runs a real-time or embedded operating system such as VxWorks or Linux. The Host CPU 120 is connected to the Host CPU RAM 124 through connection 123 which can be any type of memory bus. The Host CPU 120 is connected to an Electrically Erasable Programmable Read Only Memory (EEPROM) 122 through connection 121 which can be any type of memory bus. The EEPROM 122 could consist of one or more devices. The EEPROM 122 contains the firmware for the entire Network Processor-based Compute Element 110 and is loaded by the Host CPU 120 after power is turned on. The Host CPU 120 can update the EEPROM 122 image at any time. This feature allows the Network Processor-based Compute Element 110 firmware to be dynamically upgrade able. The EEPROM 122 also holds state for the Compute Element, such as compute Element configurations, which are read from the EEPROM 122 when the Network Processor-based Compute Element 110 is powered on. Status LEDs 116 are connected to the Host CPU 120 over a serial or I2C connection 117. The status LEDs indicate the current status of the computer element such as operational status, and/or computing in progress. The Hot Plug Switch 118 is connected to the Host CPU 120 over a serial or I2C connection 119. The Hot Plug Switch 118 allows the Network Processor-based Compute Element 110 board to be added or removed from a chassis even though the chassis power is on. The Network Processor-based Compute Element 110 has a Rear Connector 126 that connects to a chassis allowing several controllers to be grouped together in one chassis. The Rear Connector 126 has an I2C connection 125 that allows the Host CPU 120 to report or monitor environmental status information, and to report or obtain information from the chassis front panel module. The Rear Connector 126 would also pick up the necessary power from the chassis to run the Network Processor-based Compute Element 110.

Referring again to FIG. 9, the Network Processor-based Compute Element 110 could also have additional special purpose hardware not shown in FIG. 9. This hardware could accelerate data encryption operations, and/or data compression operations. This hardware is added to the invention as needed. Adding the hardware increases performance but also increases the cost.

It is important to note that a network processor is optimized for moving data. The present invention allows the combination of a computer processor with a network processor. The network processor feeds the compute element the data that it needs enabling the compute element to use storage resources available on a network.

The present invention can support most storage access protocols. More specifically it can handle Network Attached Storage protocols such as the Network File System (NFS) or the Common Internet File System (CIFS), it can support Network Storage protocols such as SCSI, iSCSI, Fibre Channel, Serial ATA, and Serial SCSI. The network processor performs the protocol processing.

It is important to note that nothing in the present invention prevents the aggregation of N number of Network Processor-based Compute Elements into a single virtual computer server or computational grid. This is a separate invention covered in another patent application by the inventor.

The rest of the discussion will present examples of how the network processor in the present invention would store or retrieve data for the host CPU. No error handling is shown in the figures or discussion but is performed by the present invention.

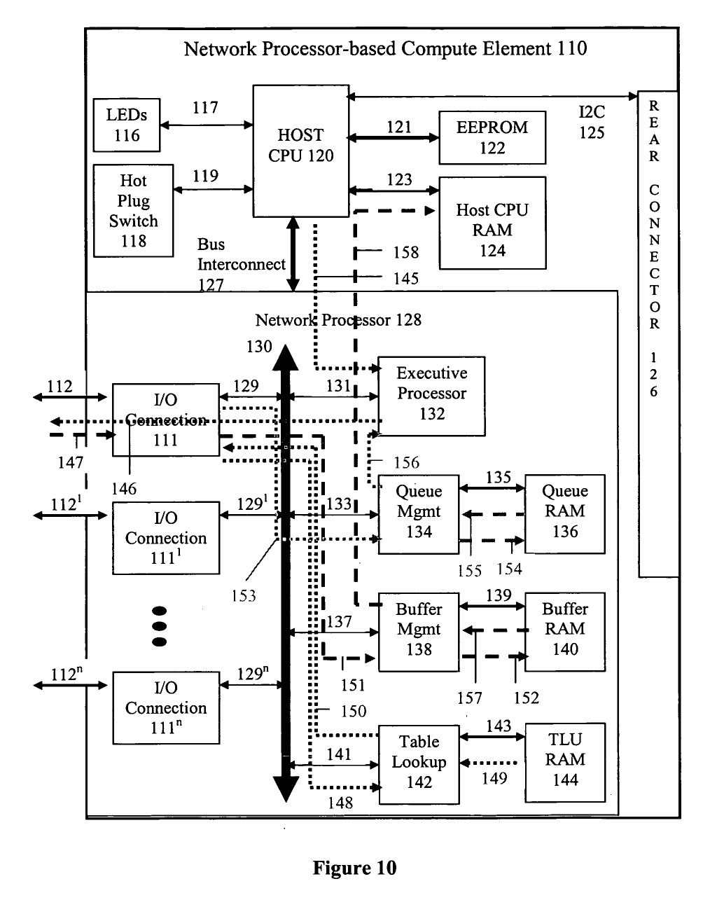

Referring to FIG. 10 is an illustration of a request by the Host CPU 120 for data from the network to be loaded into the Host CPU RAM 124. The Host CPU 120 sends a request for the data over Bus Interconnect 127 to the Executive Processor 132 as shown by arrow 145. The Executive Processor 132 processes the request, possibly doing a lookup with the TLU 142 which is not shown in FIG. 10, and determines which storage server to send it to and forwards the request over bus connection 131 through system busses 130 and over bus connection 129 to I/O Connection 111 and out to the network through network connection 112. Arrow 146 shows the path. Arrow 147 shows the data coming in from a storage server on the network through connection into I/O connection 111. As I/O Connection 111 starts receiving the start of the data packet, but not the entire data packet, it will collect the bits until it has enough to do a table lookup to determine what to do with the incoming packet. Arrow 148 shows the table lookup request going from I/O Connection 111 across bus connection 129 through the system busses 130 and then through bus connection 141 to the TLU 142. The TLU 142 will perform a table lookup searching the information in the TLU RAM 144 that results in reads of the TLU RAM 144 over connection 143 as shown by arrow 149. The TLU 142 will either return actions if the actions for processing that type of data packet are in the table, or an indication that no actions were found. Arrow 150 shows the action information being returned from the TLU 142 through bus connection 141 through the system busses 130 and then through bus connection 129 to I/O Connection 111. If no actions were returned then the packet would be forwarded to the Executive Processor 132 to determine how to process the packet. This is not shown in FIG. 10. Assuming that the TLU 142 returned actions to the I/O Connection 111 through arrow 150 indicating that the packet needs to be sent to the Buffer Management Unit 138. The action information returned would include information for addressing the packet to the proper internal component. Typically before all the data from the packet has arrived at the I/O Connection 111, it will receive the action information from the TLU 142. For this example, it will send the data read to the Buffer Management Unit 138. Arrow 151 shows this path where the data read is sent over bus connection 129 through internal busses 130 and over bus connection 137 to the Buffer Management Unit 138 where it is sent over connection 139 to the Buffer RAM 140 as shown by arrow 152. The I/O Connection 111 would then send notification to the Queue Management Unit 134 over bus connection 129 through internal busses 130 then over bus connection 133 to the Queue Manager Unit 134 as shown by arrow 153. The queue entry contains a pointer to the buffered packet in the Buffer Management Unit 138 and a reference that the packet is to go to the Host CPU 120. The Queue Management Unit 134 will store the queue entry in Queue RAM 136 as shown by arrow 154. When the Queue Management Unit 134 determines that it is time to de-queue the entry then it will read Queue RAM 136 as shown by arrow 155. The Queue Management Unit 134 will then send a message over bus connection 133 through system busses 130 and over bus connection 131 telling the Executive Processor 132 to transmit the packet to the Host CPU 120. This path is shown by arrow 156. The Executive Processor 132 will request the packet from the Buffer Management Unit 138 and the Executive Processor 132 would then send the packet to the Host CPU RAM 124. The packet would go from the Buffer RAM 140 over connection 139 to the Buffer Management Unit 138 as shown by arrow 157. The Buffer Management Unit 138 would send the packet over bus connection 137 over internal busses 130 through Bus Interconnect 127 through Host CPU 120 over memory connection 123 to the Host CPU RAM 124. This path is shown by arrow 158.

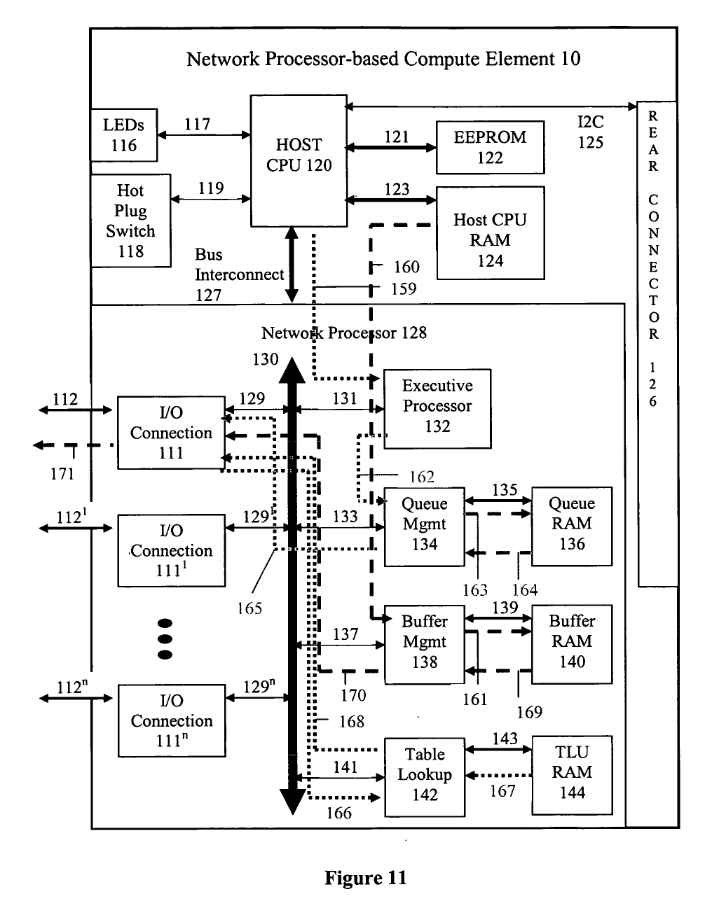

Referring to FIG. 11 is an illustration of a request by the Host CPU 120 to write data from Host CPU RAM 124 to a storage server on the network. The Host CPU 120 sends a request to write the data over Bus Interconnect 127 to the Executive Processor 132 as shown by arrow 159. The Executive Processor 132 processes the request, possibly doing a lookup with the TLU 142 that is not shown in FIG. 11, and determines which storage server to write the data to. The Executive Processor 132 then transfers the data from Host CPU RAM 124 over memory connection 123 through Host CPU 120 over Bus Interconnect 127 and over internal busses 130 through bus connection 137 to the Buffer Management Unit 138 as shown by arrow 160. The data is sent to Buffer RAM 140 over connection 139 as shown by arrow 161. The Executive Processor 132 would then send notification to the Queue Management Unit 134 over bus connection 131 through internal busses 130 then over bus connection 133 to the Queue Management Unit 134 as shown by arrow 162. The queue entry contains a pointer to the buffered packet in the Buffer Management Unit 138 and a reference that the packet is to go to a specific storage server. The Queue Management Unit 134 will send the queue entry over connection 135 to the Queue RAM 136 as shown by arrow 163. When the Queue Management Unit 134 determines that it is time to de-queue the entry then it will read Queue RAM 136 as shown by arrow 164. The Queue Management Unit 134 will then send a message over bus connection 133 through system busses 130 and over bus connection 129 telling the I/O Connection 111 to transmit the packet to the storage server. This path is shown by arrow 165. The I/O Connection 111 would then do a table lookup request to get the exact address for the storage server. Arrow 166 shows the table lookup request going from I/O Connection 111 across bus connection 129 through the system busses 130 and then through bus connection 141 to the TLU 142. The TLU 142 will perform a table lookup searching the information in the TLU RAM 144 that results in reads of the TLU RAM 144 over connection 143 as shown by arrow 167. The TLU 142 will either return the address of the storage server or a table miss. Arrow 168 shows the storage server address information being returned from the TLU 142 through bus connection 141 through the system busses 130 and then through bus connection 129 to I/O Connection 111. If no storage server address information were returned then the queue information would be forwarded to the Executive Processor 132 to determine how to address the packet. This is not shown in FIG. 11.

Assuming that the TLU 142 returned the address of the storage server to the I/O Connection 111 through arrow 168 then I/O Connection 111 would transfer the buffer from the Buffer Management Unit 138, where the packet would be read from Buffer RAM 140 over connection 139 and then transferred over bus connection 137 through internal busses 130 over bus connection 129 to I/O Connection 111 as shown by arrow 170. I/O Connection 111 would properly address the packet and then send it out over network connection 112 to the appropriate storage server as shown by arrow 171.

1. A data storage controller providing network attached storage and storage area network functionality, said storage controller comprising:
a network processor;
means for volume management, preferably one or more of mirroring means, RAID5 means, and copy on write backup means;
means for caching of data stored;
means for protocol acceleration of low level protocols, preferably one or more of ATM, Ethernet, Fibre Channel, Infiniband, Serial SCSI, Serial ATA, and any other serializable protocol; and
means for protocol acceleration of higher level protocols, preferably one or more of IP, ICMP, TCP, UDP, RDMA, RPC, security protocols, preferably one or both of IPSEC and SSL, SCSI, and file system services, preferably one or both of NFS and CIFS.

2. A storage controller according to claim 1, further comprising:
means for changing host-side I/O connections to storage-side I/O connections dynamically; and
means for changing storage-side I/O connections dynamically to host-side I/O connections; and
wherein the I/O connections are protocol independent.

3. (canceled)

4. A storage controller switch comprising:
a network processor;
means for switching data from a source I/O port to a destination I/O port; and
means for performing storage management functionality, wherein the storage management functionality includes volume management, preferably one or more of mirroring, RAID5, and copy on write backups, caching of data stored, and file system services, preferably one or both of NFS and CIFS.

5. A compute element or compute blade comprising a networking switch, wherein the networking switch handles all I/O communications between compute element processor or processors and a computer network, storage network, and/or direct attached storage.

6. A compute element or compute blade according to claim 5, wherein the compute element has been built-in hardware assisted protocol processing for networking and storage protocols that allow data to be read and/or written from the compute element processor or processors.

7. An I/O interface comprising:
means for allowing protocols used on a physical connection to be changed dynamically through software control without replacing a card for the physical connection;
means for keeping the I/O interface independent of protocols that it processes;
means for allowing the I/O interface to provide protocol processing capabilities for higher level protocols, preferably one or more of IP, ICMP, TCP, UDP, RDMA, RPC, security protocols, preferably one or both of IPSEC and SSL, SCSI; and
means for providing storage management processing capabilities, preferably for one or more of volume management, preferably one or more of mirroring, RAID5, and copy on write backups, caching of data stored, and file system services, preferably one or both of NFS and CIFS.
